(19) United States
(12) Patent Application Publication
(10) Pub. No.: US 2008/0041218 A1
(43) Pub. Date: Feb. 21, 2008

(54) SYSTEM AND METHOD FOR TEACHING AN INSTRUMENTAL OR VOCAL PORTION OF A SONG

(76) Inventors: Mark Hara, Maitland, FL (US); John Bryant, Orlando, FL (US); Robert Koelble, Orlando, FL (US); Abdias Garcia, Orlando, FL (US); Greg Hayworth, Winter Park, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/754,084

(22) Filed: May 25, 2007

Related U.S. Application Data
(63) Continuation-in-part of application No. 11/125,786, filed on May 10, 2005, now abandoned.

(51) Int. Cl. G09B 15/00; G10H 7/00

(52) U.S. Cl. 84/609; 84/477 R

(57) ABSTRACT

A recording of a lesson on how to play an instrumental portion of a song that has a plurality of song sections and the one or more of the song sections contains the instrumental portion. The lesson comprises instructions how to play the instrumental portion for each song section, and the instructions are arranged in a chronological sequence as the song sections occur in the song. The recording may also include a recording of a recreation of the song, and in an instruction for each song section there is a recording of the recreated song section that occurs at a beginning of the instruction. The recording may also include a recording of the recreated song section that has the instrumental portion removed and can be played back without interruption so a student may play the instrumental portions as the recording is played.

### CROSS-REFERENCE TO RELATED APPLICATIONS

This is a Continuation-In-Part of U.S. application Ser. No. 11/125,786 filed May 10, 2005, which is incorporated herein by reference.

### FIELD OF THE INVENTION

This invention relates generally to musical instruction. More specifically, the invention pertains to methods or systems that may be recorded on a medium to provide a verbal lesson on how to play instrumental or vocal portions of a song without the need for written music.

### BACKGROUND OF THE INVENTION

Some methods used for teaching and/or learning how to play instruments such as stringed instruments, keyboards and/or percussions includes the use of printed tablature. A tablature notates music as a series of playing positions. For example, a tablature for a stringed instrument guides the student's fingers to the string that must be plucked and the fret at which the string is stopped. Such tablatures are published in manuals or instructional videos and persons often use these materials to teach oneself how to play a guitar or how to play a particular guitar.

A guitar tablature is shown in FIG. 1, and includes a six-line staff that graphically represents the guitar fingerboard, with the top line indicating the highest sounding string (high E). By placing a number on the appropriate line, the string and fret of any note can be indicated. The number 0 represents an open string. The 0's mean that the string is played open (no finger) and the other numbers indicate which fret you place your finger on. However, such tablature typically identifies the finger with a number, which can be confusing when to referring to a fret identified with same number. Moreover, some tablatures do not include the identification of the particular finger to be used, and it is left to the student to determine which finger should be used to contact a string.

In addition, when learning to play an instrument without the assistance of an instructor, a student is constantly looking between the written music and the instrument to determine if his/her hands, fingers or feet are properly positioned to play a note or chord. This movement of the head may cause confusion, disorientation and frustration. Moreover, for those students or artist that have impaired vision or are blind, the written music and/or tabulation provide no instruction. While written music and/or tabulation may be available in Braille, a similar problem exists, as a student may have to move his/hands between the music or tabulation and the instrument.

Using an instructor to assist a student or performer with the written music and the tabulation can alleviate the student's focus on the written music and/or tabulation. The instructor may verbally communication the information; while the student can focus on the instrument and the position of his/her hands relative to the instrument. A problem associated with taking lessons from an instructor is the expense. While some instructors may be more or less than others, some students simply can't afford an instructor. In addition, schedules of a student and those of the instructor often conflict, so the student cannot take lessons at times convenient to the student. Accordingly, a need exists for some, system, method and/or medium to provide an oral or verbal instrument lesson that uses a form of music tabulation that avoids the problems of expense and scheduling associated with hiring an instructor.

### SUMMARY OF THE INVENTION

The present invention is for a system and method for teaching an instrumental portion or vocal portion of a song. In accordance with the present invention, the lesson is entirely verbal without reference to printed music or tablature diagrams. The lesson may be recorded on any medium that can store and replay the lesson, such as compact discs, cassette tapes or available databases making the lesson downloadable from the internet.

### BRIEF DESCRIPTION OF THE DRAWINGS

FIG. 1 is a tablature diagram.

FIG. 2 is a flow chart for the process of selecting a song that is subject to a lesson.

FIG. 3 is a flow chart for the recreation and recording of the song.

FIG. 4 is a flow chart for the creation of a script of the lesson.

FIG. 5 is a flow chart for the steps for the pre-production and recording of the lesson.

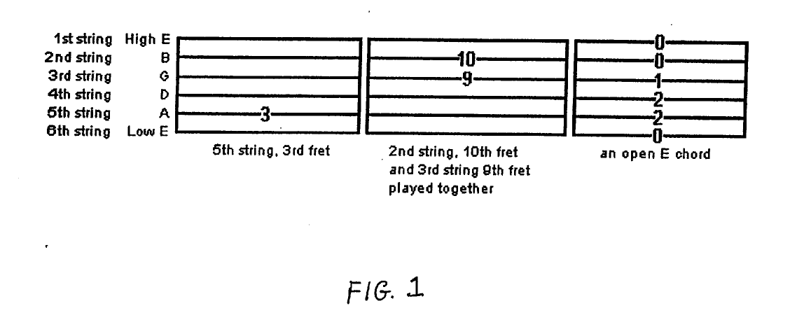

### DETAILED DESCRIPTION OF THE INVENTION

The present invention for a novel instructional system and method for teaching a person how to play a musical instrument utilizes solely audio instructions without the need of diagrams, instructional manuals or the like. The lesson may also be utilized in an in-person lesson with an instructor. The lesson may be recorded on any appropriate medium such as a cassette tape, compact disc, or may be downloaded if provided via the Internet, or transmitted via a radio signal. The system and method may incorporate tablature method for identifying notes and chords which tablatures are verbally communicated via the chosen medium or in person. While reference is made to a recorded guitar lesson, the invention is not so limited and may include lessons related to other musical instruments such as the piano or drums and other stringed instruments.

In an embodiment, the lesson is recorded on a medium such as a compact disc for replay, and a script of a lesson is provided herein as an Appendix. Embodiments described in this disclosure are presented in the context of a compact disc; however, other recordable mediums such as cassette tapes, computer hard drives, etc. that are capable of storing and/or recording a song may be used. Accordingly an embodiment may include a compact disc having a first track that includes data representative of a recorded recreation of the song that may be played prior to beginning the lesson. A second track includes a plurality of tracks and on each track data is stored, which data is representative of the lesson for teaching an instrument that is played in the song. In addition, the disc may have a third track that has stored data representative of the recreated song with the instrument or vocal that is the subject of the lesson removed or muted so a student may play along as the song is played.

As shown in the script set forth in the Appendix, the song includes multiple components such as the introduction, a plurality of verses, pre-chorus, chorus etc. The particular script shown in the Appendix includes a lesson on how to play the guitar. The lesson divides the song into its separate components (or sections) and identifies the number of bars in each sections, the chords or notes to be played and an instruction how to play each chord and/or note, and how to play the bars of the song section. For example, on page 1 of the Appendix there is the introduction of the song, which on a compact disc there is stored data representative of the verbal lesson and data representative of the introduction of the recreation of the song with the instrumental. More specifically, an instructor identifies the section of the song to be taught and the number of bars in the section. Then the recreation of the section is played so the student can hear that section of the as it supposed to be played. Then the instructor identifies the different chords or notes to be played in the section and may use a form of tablature to teach how a student may play the chords and/or notes and the section of the song.

As shown on page 2 of the Appendix, there is a portion of the song including the first verse. The section of the song is first identified as the first verse, and the number (8) of bars is identified. Then the recreation of the first verse is played. The instructor then goes on to identify the different chords and/or notes for the first verse and an instruction on how to play the chords and/or notes for the first verse. The lesson or instructions for each section of the song are arranged chronologically originally composed in the song. This process is repeated for each section of the song including the second verse on page 2 of the Appendix, the first pre-chorus beginning on page 3 of the Appendix, the first chorus beginning on page 6, the third verse beginning on page 6, the second pre-chorus beginning on page 7, the second chorus beginning on page 7, the bridge begging on page 13, the interlude beginning on page 9, the fourth verse beginning on page 10, the third pre-chorus beginning on page 11, the third chorus beginning on page 11 and the outroduction beginning on page 11.

Each section of the song may include multiple components so the compact disc may have data stored on one or more tracks, which data is representative of lessons or instructions associated with each song section. In an embodiment, for each song section, there is data stored on a track that is representative of a recreation of that section of song so that section of the song may be played prior to beginning the portion of the lesson. In an embodiment, the guitar portion of the song is muted and the instructor plays the guitar portion with the song.

In addition, the compact disc may include a track having stored data that is representative of the recreation of the song in its entirety with the instrument or vocal portion being taught removed or muted so the student may play along with the recreated song. In the example script set forth in the Appendix the guitar portion is muted. This data is stored on the compact disc so that the recreation of the song with the muted instrument is played back at the end of the lesson. In an embodiment, data representative of crowd noise may be mixed in the recreated song, and stored on a track at the end of the lesson.

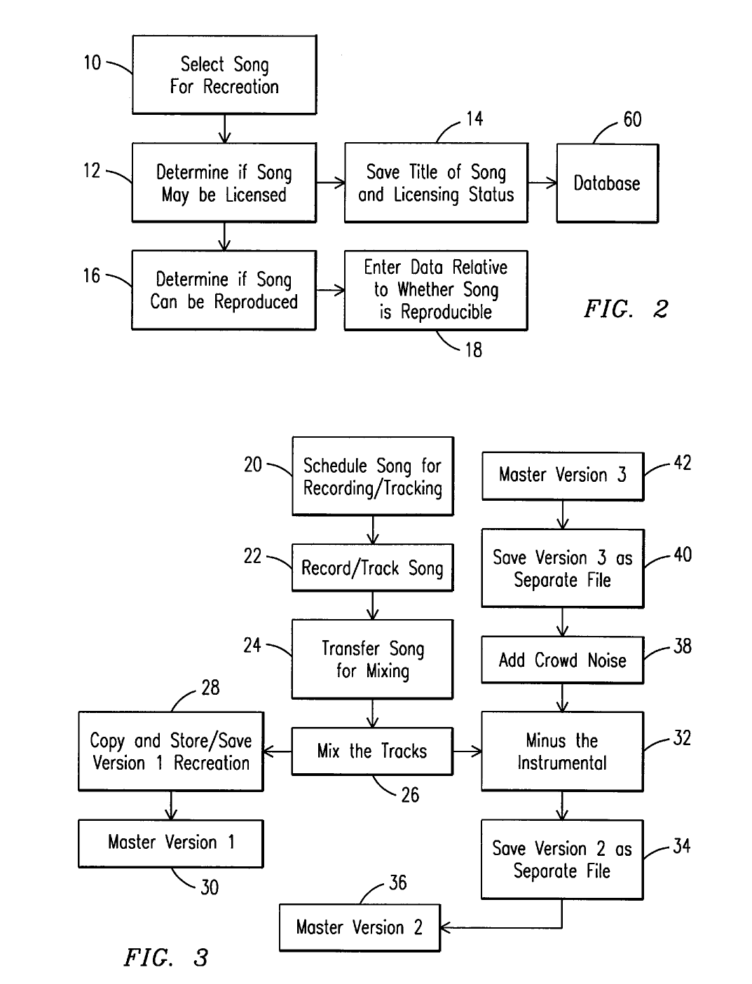

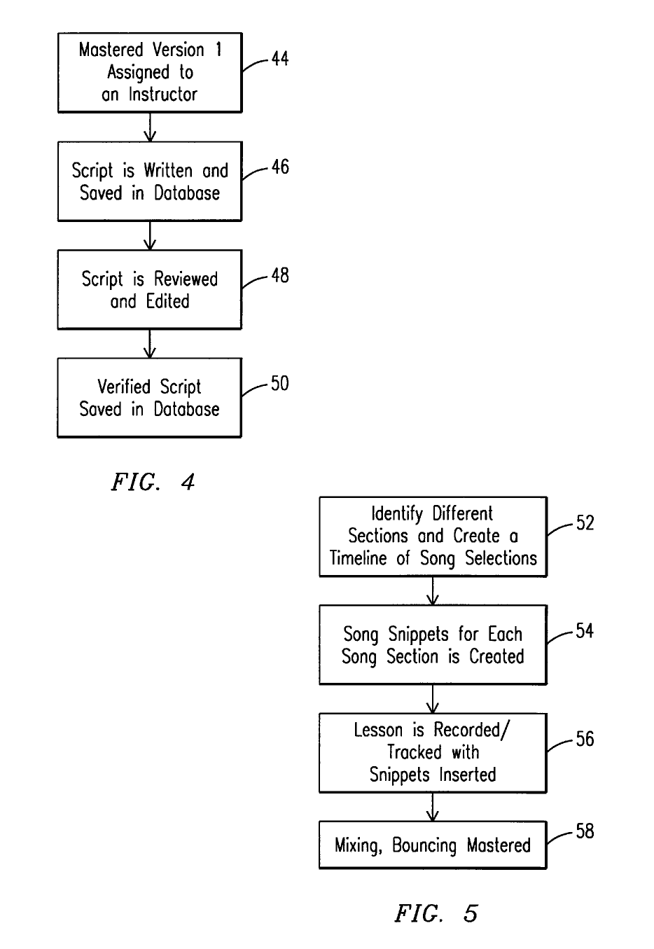

As part of an embodiment of the invention, and with reference to the flow chart in FIG. 2, in step 10 one or more songs are identified and/or selected for teaching a musical instrument lesson. Various websites or publications, such as Billboard or I-Tunes®, may list songs according to fields such as popularity, music genre or artists' names. In addition, criteria such as educational relevance with the instructional system may be considered. The educational relevance may relate to whether one or more musical instrument or vocal parts of the song is capable of being taught, and the level of skill required to perform a musical instrument part.

With respect to step 12, one must determine if the song is available for recordation and/or publication. One may contact various licensing agencies that retain a catalog of publishers' names and song titles. One such agency is the Harry Fox Agency having a website www.harryfox.com. If the song is available for publishing and licensing, a license may be obtained at this stage prior to production, or later after the song has been recreated and is mixed with a recorded lesson.

As set forth in step 14 a database 60 may be maintained containing data representative of song titles and artist name of songs selected for recreation. The data may also be organized according to music genre such as country, rock, pop, jazz etc. The database may also contain data relative to whether the song can be licensed. For example, with reference to step 14, if the song cannot be licensed, the song title may still be stored on the database, which may be updated if the song eventually is licensable.

With respect to step 16, the song is reviewed and analyzed to determine if it is reproducible. Certain songs may be too complicated to be practically reproduced. As noted above, and described below, the song is recreated and recorded. Accordingly, musicians may be hired to learn and record the songs. This requires scheduling dates and times to record the songs. If the song is too complicated in terms of scheduling musicians, the song may not be practically recreated. In step 18 data relative to whether or not the song is reproducible is entered into a database to update the status of the song. If the song is not reproducible, the song may be reproducible at a later date. For example, the system may have sufficient number of musicians and available recording time to reproduce the song, or lessons may have been developed to instruct more complex instrumentals or vocals. If it is determined that the song is reproducible, then the song is scheduled for recording.

At this point, and in reference to step 20 and 22 in FIG. 3, a selected song is recreated by musicians and recorded preferably in digital format in order to integrate the song with a recorded lesson. The song is first scheduled for recording (also referred to as tracking), which includes identifying the musicians available that can recreate the song, and scheduling dates and times the musicians are available to recreate and record the song.

As known to those skilled in the art of music recording, the components of a song may be recorded separately and saved in digital format and later mixed to recreate the song. For example, one or more guitar portions may be recorded separate from for example from the drum portion, keyboard portion or vocals. These portions are each stored on a hard drive, which is then transferred, as in step 24, for mixing which is also referred to multiplexing. Equipment and software known to those skilled in the art may be used to record, mix and master the recreated song. For example, Digidesign, Inc. produces a software product known as Pro Tools that may be used in the recording, mixing and mastering of the recreated song.

Typically when a song is recorded the data relative to the separately recorded components for instrumental and vocal portions are stored on a hard drive. With respect to step 24 the recorded recreation is transferred to an engineering department where the separately recorded components are mixed (step 24), or multiplexed to create a recreated original version of the song. In step 26, the song is copied and stored/saved as a first version that includes all the components including all the instrumental and vocal portions. This version of the song is then mastered, which means. This first version (also referred to as “version 1”) is then saved/stored in a computer database such as a database on server. The first version is used to create song snippets that are inserted into the lesson at predetermined locations within the lesson

With respect to step 32, the instrumental or vocal portion of the song to be taught is muted or removed from the original version and saved as file in step 34 separate from the mastered first version. In step 34, the song is then copied and saved as a second version (“version 2”) which has the instrumental muted or removed. This second version is then mastered in step 36, and, as described below, will be saved or stored on a compact disc on a track at the end of the lesson, so a student may play the song on the compact disc with an instrumental or vocal portion removed.

With respect to step 38 crowd noise may be added to the mixed version having the instrumental or vocal portion removed; however, this step 38 is optional, and the crowd noise does not have to mix with song. This version 3 or third version is saved as a file separate from the first version and second version, in step 40, and then mastered in step 42.

During the course of recreating and recording a song, various quality control measures may be taken to verify the accuracy of the recordation. For example, after the different components of the song have been recorded, and prior to mixing the components, the recordings may be reviewed in order to determine if each component has been properly played as closely as possible to the original song. In addition, a similar verification step may be implemented after the different versions 1, 2 and 3 have been mastered.

In addition, the database 60 referred to paragraph 21 above that contains may be updated throughout the recreation and recording process by entering data relative to the stage of the production including dates and times when steps are scheduled to be performed or when steps have been performed. In this manner, any person involved with the creation of an end product can determine status of any particular song.

With respect to FIG. 2, there is a flow chart describing the scripting stage of an embodiment of the invention. The mastered version 1 (above-referenced first version) is then assigned to an instruction in step 44, which instructor then prepares and saves in a database a scripted lesson relative to the song, and as set forth in step 46. With respect to the script set for in the Appendix, one or more templates is provided that contain contains the typical sections of the songs, which may be added or deleted according to what is contained in the version 1 of the recreated song. Text relative to the instructions on how to play or sing a portion of the song is added or inserted to the template as needed.

In an embodiment of the invention a step 48 may be included for reviewing and/or editing the script, after which a verified script is saved (step 50) in the database. Accordingly, the database 60 may contain data relative to the song title, status of production of the recreation of the song, status of assignment or preparation of the script, the script itself and relevant dates and times acts or steps are scheduled to be performed and dates and times of when steps have been performed.

With respect to step 52, shown in FIG. 3, the different sections of the song are identified and a timeline of the song sections is created. As shown on page 12 of the Appendix, a timeline is illustrated having each section of the song identified and a time increment associated with each song. The song sections and time increments are listed in the chronological order as the song sections occur in the song. An engineer may reference this timeline when recording a scripted lesson in order to insert or introduce a snippet of the song into a corresponding song section lesson as described below in more detail.

In step 54 song snippets are created from one or more of the three versions of the song. In an embodiment, the snippets are copied from the version 1, which contains the song in its entirety including all the instrumentals and vocals. The snippets are saved in a database and associated or identified by the name of the song section the snippet is associated and the chronological time increment in which the snippet occurs in the song. Software such as Pro Tools identified above has databases referred to as sessions in which the snippets and the different versions of the song is recorded. In addition the recorded lesson may stored in a session.

To that end, in step 56 the lesson is recorded. An instructor reads the script, and at the appropriate intervals the snippets are inserted in the recording. For example, in reference to the script set forth in the Appendix, more specifically page 1 of the Appendix. The instructor reads the section for the introduction of the song:
The first section of the song is the introduction. The introduction is 2 bars in length. Here is how it sounds:

At this point the snippet for the introduction of the song is played and recorded. Then the instructor begins reading the script again, including the lesson how to play the chords and/notes for the introductory section. This process is repeated for each of the song sections in the chronological order the sections occur in the song, with the snippets inserted or recorded at the beginning of each lesson for a given section.

In an embodiment, the second version of the song that has the instrumental or vocal portion muted is recorded on a track after the lesson is completed and recorded. So that at the end of the lesson, a student can play or sing the respective instrumental or vocal portion along as the song is being played. In addition, or alternatively, the third version of the song having the instrumental or vocal portion muted and having crowd noise mixed with the music is recorded on a track after the lesson is completed or recorded.

After the lesson is recorded with the snippets and other song versions, the recording is subject to known editing, mixing and bouncing procedures so the final version is ready to be mastered. Bouncing can be done using software available through I-Tunes®. The editing may include quality control measures to determine the accuracy of the lesson. The recording is then completed a stored on a compact disc and readied for marketing.

While the embodiments of the invention have been shown and described herein, it will be obvious that such embodiments are provided by way of example only and not of limitation. Numerous variations, changes and substitutions will occur to those of skilled in the art without departing from the teaching of the present invention. Accordingly, it is intended that the invention be interpreted within the full spirit and scope of the appended claims.

1. A recording of a lesson on how to play an instrumental portion of a song, comprising:
a recording of a lesson how to play an instrumental portion of a song that has a plurality of song sections and one or more of the song sections contains the instrumental portion, the lesson having instructions how to play the instrumental portion for each song section wherein the instructions are arranged in a chronological sequence as the song sections occur in the song, and wherein the song having been recreated and recorded, and in an instruction for each song section there is a recording of the recreated song section that occurs at a beginning of the instruction.

2. The recording of claim 1 wherein a recording of the recreated song occurs in its entirety at the end of the lesson and has the instrumental portion of recreated song removed so a student may play the removed instrumental portion as the song is played.

3. The recording of claim 2 further comprising on the recording an introduction identifying the song title and name of an artist attributed to the song, and a recording of the recreated song including the instrumental portion to be taught which recording of the recreated song occurs without interruption after the introduction and before the lesson.

4. The recording of claim 1 wherein the instrumental portion of the song is a stringed instrument.

5. The recording of claim 1 wherein the instrumental portion of the song is a keyboard instrument.

6. The recording of claim 1 wherein the instrumental portion of the song is percussion instrument.

7. The recording of claim 1 wherein the lesson includes tablature instructions identify where hands, fingers or feet are placed relative to an instrument to play a note or chord.

8. The recording of claim 1 wherein the lesson is read from a script when recorded.

9. A system having a medium on which data is stored relative to a lesson for learning how to play an instrumental portion of a selected song, wherein the lesson is recorded in a plurality tracks, the system comprising:
data, stored in a plurality of tracks, relative to a recorded lesson that identifies different sections of a song and instructions how to play an instrumental portion in one or more of the sections of the song, and the instructions for the song sections are arranged in a chronological order as they occur in the song, and for each identified section there is data relative to a recording of a recreation of a corresponding song section.

10. The system of claim 9 wherein the data relative to the recorded recreated song section is stored that when played back, the recorded recreated song occurs in the lesson at a beginning of the instruction for the corresponding song section.

11. The system of claim 9 further comprising the lesson is read from a script while recorded.

12. The system of claim 9 further comprising data, stored as on or more tracks, relative to a recorded recreation of a song wherein the recreated song can be played back in its entirety without interruption from the first track.

13. The system of claim 12 wherein the data relative to the recreated song is stored on the medium whereby the song is played back in its entirety without interruption prior to the lesson beginning.

14. The system of claim 9 further comprising data, stored as one or more tracks, relative to a recording of the recreated song with the instrumental portion removed, and the recreated song can be played back in its entirety uninterrupted with the instrumental portion removed.

15. The system of claim 14 wherein the data relative to the recreate song with the instrumental portion removed is saved such that it occurs at an end of the lesson so the student may place the removed instrumental portion when the song is played back.

16. The system of claim 9 further comprising data, stored as one or more tracks, relative to a recording of the recreated song with the instrumental portion removed and the data including data representative of crowd noise, and the recreated song can be played back in its entirety uninterrupted with the instrumental portion removed.

17. The system of claim 16 wherein the data relative to the recreate song with the instrumental portion removed is saved such that it occurs at an end of the lesson so the student may place the removed instrumental portion when the song is played back.

18. The recording of claim 9 wherein the instrumental portion of the song is a stringed instrument.

19. The recording of claim 9 wherein the instrumental portion of the song is a keyboard instrument.

20. The recording of claim 9 wherein the instrumental portion of the song is a percussion instrument.

21. The recording of claim 9 wherein the lesson includes tablature instructions identify where hands, fingers or feet are placed relative to an instrument to play a note or chord.

22. A method of teaching an instrumental portion of a song having a plurality of song sections, the method comprising:
recording on a medium for play back a lesson for teaching an instrumental portion of the song comprising a plurality of song sections, wherein the lesson is read from a written script that has an instruction for the instrumental portion for each song section, and the instructions are arranged in a chronological order as the song sections occur in the song, wherein the lesson is recorded in a digital format;
recording on a medium on play back a recreation of the song in a digital format;
identifying each recorded song section making up the recorded recreation of the song;
mixing each recorded song section with a corresponding instruction for the song section.

23. The method of claim 22 wherein each of the recorded song sections is mixed with a corresponding instruction for the song section as the lesson is recorded.

24. The method of claim 23 wherein each recorded song section occurs at a beginning of the corresponding instruction of the section when the recorded lesson is played.

25. The method of claim 22 wherein the recorded recreation of the song containing the instrumental portion is mixed with the lesson so it is played without interruption before the lesson begins.

26. The method of claim 22 further comprising the step of removing from the recorded recreation of the song the instrumental portion of the song to be taught, and mixing the song with the removed in instrumental portion with the recorded lesson.

27. The method of claim 26 wherein the recorded recreation of the song having the instrumental portion removed occurs at the end of lesson when the lesson is played on the medium so a student may play the removed instrumental portion.

28. The method of claim 27 wherein the recorded recreation of the song containing the instrumental portion is mixed with the lesson so it is played without interruption before the lesson begins.

29. The method of claim 22 further comprising obtaining a license to record the song.

30. The method of claim 22 further comprising obtaining a license to record the song and distribute a recording of the song.

31. A method of teaching an instrumental portion of a song having a plurality of song sections, the method comprising:
selecting a song having one or more instrumental portions for providing a lesson on an instrumental portion of the song, and the song having a plurality of song sections;
obtaining a license to record the song;
recreating and recording a first version of the song in digital format;
copying each song section from the first version, and each song section is stored in an available database as a separate file forming a second version of the recorded recreation of the song;
copying, from the first version, a third version of the recorded recreation of the song, and removing the instrumental portion of the song forming a third version of the recorded recreation of the song;
creating a script of a lesson for playing the instrumental portion to be taught, wherein the lesson includes an instruction how to play the instrumental portion for each song section, and the instructions for each song section in the script occurs in a chronological order as the song sections occur in the song;
recording on a medium in digital format for play back the lesson for teaching an instrumental portion of the song comprising a plurality of song sections, which lesson is read from the script;
mixing the second version of the recorded recreation of the song with the lesson as the lesson is recorded whereby each recorded song section occurs within the lesson at a beginning of the corresponding instruction when played; and
mixing the third version of the recorded recreation having the instrumental portion removed with the recorded lesson whereby the third version occurs in the lesson at the end of the instructions.

32. The recording of claim 31 wherein the instrumental portion of the song is a stringed instrument.

33. The recording of claim 31 wherein the instrumental portion of the song is a keyboard instrument.

34. The recording of claim 31 wherein the instrumental portion of the song is a percussion instrument.

35. The recording of claim 31 wherein the lesson includes tablature instructions identify where hands, fingers or feet are placed relative to an instrument to play a note or chord.

36. A recording of a lesson on how to sing a vocal portion of a song, comprising:
a recording of a lesson how to play a vocal portion of a song that has a plurality of song sections, the lesson having instructions how to play the instrumental portion for each song section wherein the instructions are arranged in a chronological sequence as the song sections occur in the song, and wherein the song having been recreated and recorded, and in the instruction for each song section there is a recording of the recreated song section that occurs at a beginning of the instruction.
